(19) United States
(12) Patent Application Publication
(10) Pub. No.: US 2008/0168077 A1
(43) Pub. Date: Jul. 10, 2008

(54) PRE-LOADING OF AN IN MEMORY DATABASE

(76) Inventors: Eric Lawrence Barsness, Pine Island, MN (US); David L. Darrington, Rochester, MN (US); Amanda Peters, Rochester, MN (US); John Matthew Santosuosso, Rochester, MN (US)

Correspondence Address: MARTIN & ASSOCIATES, LLC, P.O. BOX 548, CARTHAGE, MO, 64836-0548, US

(21) Appl. No.: 11/621,696

(22) Filed: Jan. 10, 2007

(51) Int. Cl. G06F 7/00; G06F 13/00

(52) U.S. Cl. 707/101; 711/154; 707/E17.005; 711/E12.002

(57) ABSTRACT

A method and apparatus for pre-loading an in memory database in a parallel computing system. A node manager uses empirical evidence gained from monitoring prior query execution times and patterns to determine how to effectively load the in memory database. The structure of the database may also be analyzed to determine effective ways to pre-load the database. The node manager may also allow a system administrator to force placement of database structures in particular nodes.

### BACKGROUND OF THE INVENTION

1. Technical Field

This invention generally relates to computer database systems, and more specifically relates to pre-loading of an in memory database such as in the memory of a massively parallel super computer.

2. Background Art

Supercomputers and other highly interconnected computers continue to be developed to tackle sophisticated computing jobs. One type of highly interconnected computer system is a massively parallel computer system. A family of such massively parallel computers is being developed by International Business Machines Corporation (IBM) under the name Blue Gene. The Blue Gene/L system is a high density, scalable system in which the current maximum number of compute nodes is 65,536. The Blue Gene/L node consists of a single ASIC (application specific integrated circuit) with 2 CPUs and memory. The full computer is housed in 64 racks or cabinets with 32 node boards in each rack.

Computer systems such as Blue Gene have a large number of nodes, each with its own processor and memory. This characteristic provides the opportunity to provide an in memory database, where some portions of the database, or the entire database resides completely in memory. An in memory database could provide an extremely fast response time for searches or queries of the database. However, an in memory database poses new challenges for computer databases administrators to load the data into the memory of the nodes to take full advantage of the in memory database.

Without a way to effectively load an in memory database, parallel computer systems will not be able to fully utilize the potential power of an in memory database.

### DISCLOSURE OF INVENTION

An apparatus and method is described for pre-loading an in memory database in a parallel computing system. In some embodiments, a node manager uses empirical evidence gained from monitoring prior query execution times and patterns to determine how to effectively load the in memory database. In other embodiments, the structure of the database is analyzed to determine effective ways to pre-load the database. The node manager may also allow a system administrator to force placement of database structures in particular nodes.

The disclosed embodiments are directed to the Blue Gene architecture but can be implemented on any parallel computer system with multiple processors arranged in a network structure. The preferred embodiments are particularly advantageous for massively parallel computer systems.

The foregoing and other features and advantages of the invention will be apparent from the following more particular description of preferred embodiments of the invention, as illustrated in the accompanying drawings.

### BRIEF DESCRIPTION OF DRAWINGS

The preferred embodiments of the present invention will hereinafter be described in conjunction with the appended drawings, where like designations denote like elements, and:

FIG. 1 is a block diagram of a massively parallel computer system according to preferred embodiments;

FIG. 2 is a block diagram of a compute node in a massively parallel computer system according to the prior art;

FIG. 3 is a block diagram that represents a number of nodes in a massively parallel computer system to illustrate preferred embodiments herein;

FIG. 4 is a block diagram that represents a number of nodes in a massively parallel computer system to illustrate preferred embodiments herein;

FIG. 5 represents a node file that is updated by the node manager with information about nodes and their utilization according to preferred embodiments;

FIG. 6 represents a network file that is updated by the node manager with information about network structures and utilization according to preferred embodiments;

FIG. 7 represents a query file that is updated by the node manager with information about queries according to preferred embodiments;

FIG. 8 is a flow diagram for a node manager to store node information that will be used to pre-load an in memory database according to preferred embodiments;

FIG. 9 is a flow diagram for a node manager to store network information that will be used to pre-load an in memory database according to preferred embodiments;

FIG. 10 is a flow diagram for obtaining and storing information about queries according to preferred embodiments;

FIG. 11 is a flow diagram for pre-loading an in memory database according to preferred embodiments; and

FIG. 12 is a flow diagram for determining optimal data node mapping for pre-loading an in memory database according to preferred embodiments.

### BEST MODE FOR CARRYING OUT THE INVENTION

The present invention relates to a method and apparatus for pre-loading an in memory database in a parallel computing system. The preferred embodiments will be described with respect to the Blue Gene/L massively parallel computer being developed by International Business Machines Corporation (IBM). In some embodiments, a node manager uses empirical evidence gained from monitoring prior query execution times and patterns to determine how to effectively load the in memory database. In other embodiments, the structure of the database is analyzed to determine effective ways to pre-load the database. The node manager may also allow a system administrator to force placement of structures in particular nodes.

FIG. 1 shows a block diagram that represents a massively parallel computer system 100 such as the Blue Gene/L computer system. The Blue Gene/L system is a scalable system in which the maximum number of compute nodes is 65,536. Each node 110 has an application specific integrated circuit (ASIC) 112, also called a Blue Gene/L compute chip 112. The compute chip incorporates two processors or central processor units (CPUs) and is mounted on a node daughter card 114. The node also typically has 512 megabytes of local memory (not shown). A node board 120 accommodates 32 node daughter cards 114 each having a node 110. Thus, each node board has 32 nodes, with 2 processors for each node, and the associated memory for each processor. A rack 130 is a housing that contains 32 node boards 120. Each of the node boards 120 connect into a midplane printed circuit board 132 with a midplane connector 134. The midplane 132 is inside the rack and not shown in FIG. 1. The full Blue Gene/L computer system would be housed in 64 racks 130 or cabinets with 32 node boards 120 in each. The full system would then have 65,536 nodes and 131,072 CPUs (64 racks×32 node boards×32 nodes×2 CPUs).

The Blue Gene/L computer system structure can be described as a compute node core with an I/O node surface, where communication to 1024 compute nodes 110 is handled by each I/O node that has an I/O processor 170 connected to the service node 140. The I/O nodes have no local storage. The I/O nodes are connected to the compute nodes through the logical tree network and also have functional wide area network capabilities through a gigabit ethernet network (not shown). The gigabit Ethernet network is connected to an I/O processor (or Blue Gene/L link chip) 170 located on a node board 120 that handles communication from the service node 160 to a number of nodes. The Blue Gene/L system has one or more I/O processors 170 on an I/O board (not shown) connected to the node board 120. The I/O processors can be configured to communicate with 8, 32 or 64 nodes. The service node is uses the gigabit network to control connectivity by communicating to link cards on the compute nodes. The connections to the I/O nodes are similar to the connections to the compute node except the I/O nodes are not connected to the torus network.

Again referring to FIG. 1, the computer system 100 includes a service node 140 that handles the loading of the nodes with software and controls the operation of the whole system. The service node 140 is typically a mini computer system such as an IBM pSeries server running Linux with a control console (not shown). The service node 140 is connected to the racks 130 of compute nodes 110 with a control system network 150. The control system network provides control, test, and bring-up infrastructure for the Blue Gene/L system. The control system network 150 includes various network interfaces that provide the necessary communication for the massively parallel computer system. The network interfaces are described further below.

The service node 140 manages the control system network 150 dedicated to system management. The control system network 150 includes a private 100-Mb/s Ethernet connected to an Ido chip 180 located on a node board 120 that handles communication from the service node 160 to a number of nodes. This network is sometime referred to as the JTAG network since it communicates using the JTAG protocol. All control, test, and bring-up of the compute nodes 110 on the node board 120 is governed through the JTAG port communicating with the service node. The service node includes a node manager 142 for managing the compute nodes and a database loader 144. The node manager includes historical information about activity of the nodes, networks and queries as described further below. The node manager also includes a node map. The node map 148 is a list or data file that indicates a correspondence between nodes and database structures that will be loaded into those nodes. The database loader 144 comprises software in the service node 140 that operates to load the in memory database to the memory nodes in accordance with the node map 148 as described further below.

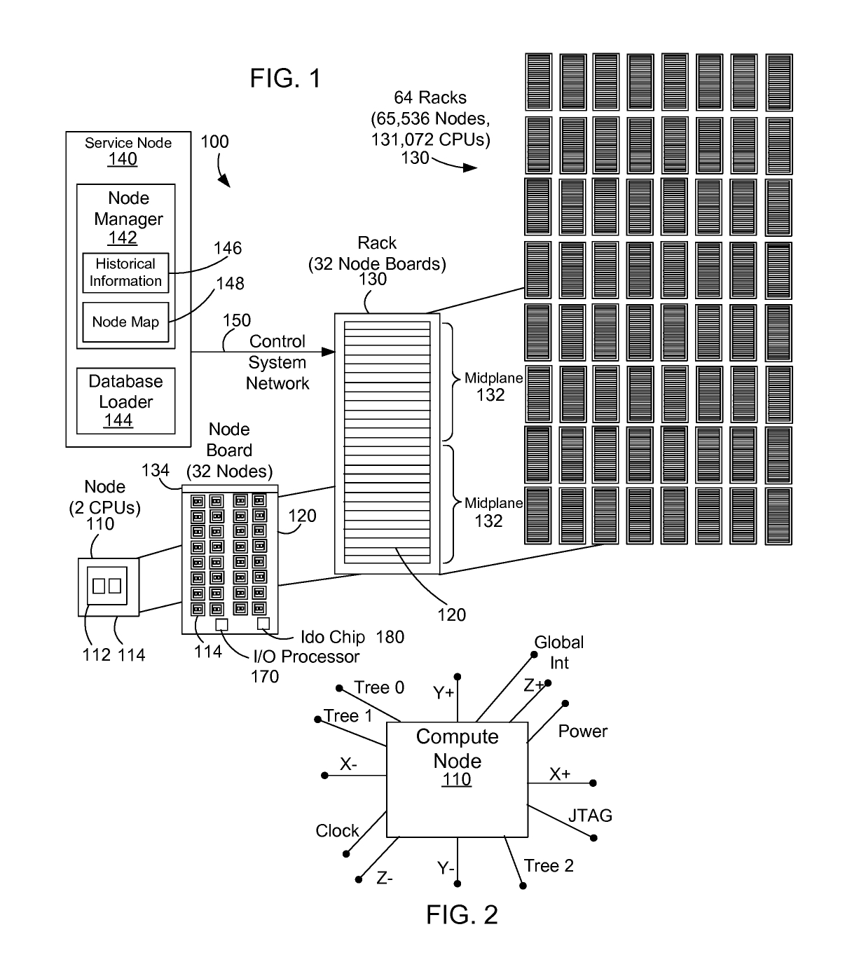

The Blue Gene/L supercomputer communicates over several communication networks. FIG. 2 shows a block diagram that shows the I/O connections of a compute node 110 on the Blue Gene/L computer system. The 65,536 computational nodes and 1024 I/O processors 170 are arranged into both a logical tree network and a logical 3-dimensional torus network. The torus network logically connects the compute nodes in a lattice like structure that allows each compute node 110 to communicate with its closest 6 neighbors. In FIG. 2, the torus network is illustrated by the X+, X−, Y+, Y−, Z+and Z− network connections that connect the node to six respective adjacent nodes. The tree network is represented in FIG. 2 by the tree0, tree1 and tree2 connections. Other communication networks connected to the node include a JTAG network and a the global interrupt network. The JTAG network provides communication for testing and control from the service node 140 over the control system network 150 shown in FIG. 1. The global interrupt network is used to implement software barriers for synchronization of similar processes on the compute nodes to move to a different phase of processing upon completion of some task. Further, there are clock and power signals to each compute node 110.

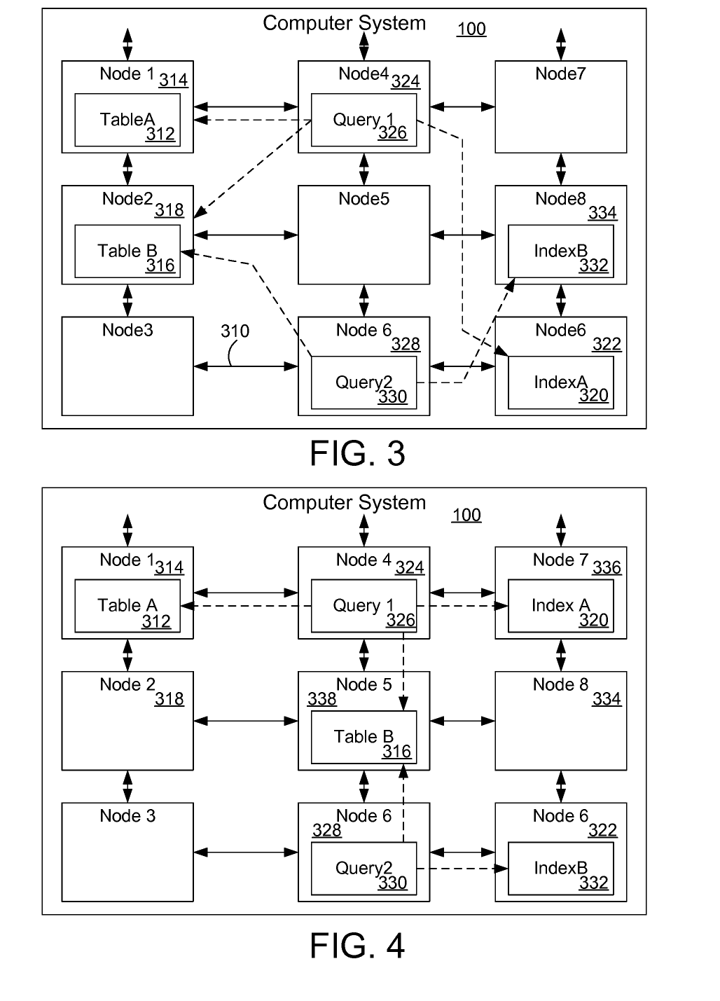

FIGS. 3 and 4 show block diagrams with several compute nodes 110 that represent a portion of a parallel computer system 100 such as the Blue Gene/L computer system. FIG. 3 and 4 together provide a broad conceptualization of pre-loading an in memory database, which is described in more detail below. The compute nodes 110 are interconnected by one or more networks as represented by the arrows between the nodes 310. The illustrated networks represent a portion of a network such as the torus network of the Blue Gene/L computer system. Each node 110 represents a fully functional computer system that has a processor and memory (not shown) as described above.

FIG. 3 illustrates an in memory database loaded to the several nodes 110 in a random fashion. The in memory database shown in FIG. 3 includes tables, indexes and applications that execute queries. Other database structures could also be included in the in memory database but are not shown in this example. These include views, metadata and other miscellaneous supporting database structures. In the example shown in FIG. 3, TableA 312 has been loaded into Node1 314, TableB 316 has been loaded into Node2 318, and IndexA 320 has been loaded into Node 6 322. Node4 324 has an application that executes Query1 326. Query1 326 uses IndexA 320, TableA 312 and TableB 316. Node6 328 has an application that executes Query2 330. Query2 330 uses IndexB 332 in Node8 334 and TableB 316. A problem that can occur with the architecture and in memory database shown in FIG. 3 is too much network traffic trying to go through the same network connection to a node or too much network traffic on a single axis. In FIG. 3, network traffic from Query1 326 to IndexA 320 could cause problems where it passes through the same network connections as the network traffic of Query2 330 accessing IndexB 332. While this is a simplified example, it illustrates that in a network with many queries operating against multiple database structures there is a problem that some network connections will become overburdened to the point of reducing overall efficiency of the system.

FIG. 4 illustrates the same in memory database as shown in FIG. 3 after a more optimal pre-loading of the in memory database. In FIG. 4, the in memory database has been pre-loaded so the various queries can more efficiently utilized the network connections of the database and not cause problems of network contention. The database loader (144 in FIG. 1) is used in conjunction with the historical information (146 in FIG. 1) to determine a more optimal loading of the in memory database as described further below. In the example shown in FIG. 4, the IndexA 320 has been moved to Node7 336 to be in close proximity to Query1 326. Similarly, IndexB 332 has been moved to Node6 322 to be inclose proximity to Query2 330. TableB 316 was moved to Node5 338 to be in close proximity to both Query1 326 and Query2 330.

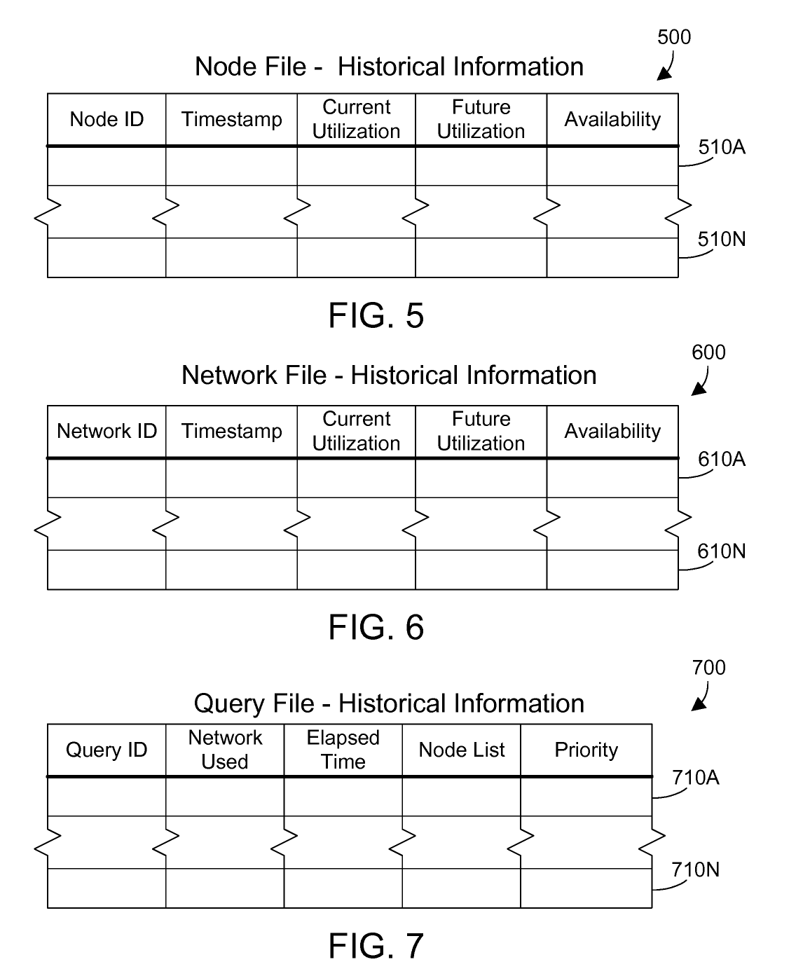

FIGS. 5 through 7 illustrate three different files that store historical information that can be used to determine how to pre-load the in memory database. These files contain historical information (146 in FIG. 1) that is stored by the node manager (142 in FIG. 1). The information may be collected by the node manager or other processes that are running on the computer system.

FIG. 5 illustrates a node file 500 that is used to pre-load an in memory database. The node file 500 contains records 510A through 510N that have information about the nodes and their utilization in the computer system. The records 510A through 510N in the node file 500 contain information such as the node ID, a time stamp, the current utilization of the node, the future utilization of the node, and the node availability. The node ID stores a node identifier for the node record 51A-510N at the time indicated by the timestamp. The current utilization represents how busy the node is in terms of CPU utilization. The node utilization could also represent the amount of memory being used, or some combination of factors. Where possible, the future utilization of the node is predicted and stored. The availability of the node indicates whether the node is available or not. An unavailable node may be reserved or non-operable.

FIG. 6 illustrates a network file 600 that is used to pre-load an in memory database. The network file 600 contains records 610A through 610N that have information about the networks in the computer system. The records 610A through 610N in the network file 600 contain information such as the network ID, a time stamp, current utilization, future utilization and network availability. The current utilization represents how busy the network is in terms of bandwidth utilization. Where possible, the future utilization of the network is predicted and stored. Similar to the node availability described above, the availability of the network indicates whether the network is available or not.

FIG. 7 illustrates a query file 700 that is used to optimally pre-load an in memory database. The query file 700 contains records 710A through 710N that have historical information about queries that have executed on the computer system. The records 710A through 710N in the query file 700 contain information such as the query name or ID, the network used, the elapsed time used for the query to execute on the node, the node list for the query, and the query priority. The network used is the name or ID of the network that the query uses to access the database structure needed for the query. The node list is a list of nodes that contain the database structure or are otherwise needed to execute the query. The query priority is an optional attribute specified by a user that indicates the importance of the query. Query history information from higher priority queries is more significant in determining the data to node mapping.

Future network utilization discussed above could be predicted based on previous statistics stored in the network file. Predicted future network utilization could also be based on history if the application has been run before or has an identifiable pattern, and could be based on information provided about the application. For example, certain types of applications traditionally execute specific types of queries. Thus, financial applications might execute queries to specific nodes while scientific applications execute queries to all of the nodes. Future node utilization could similarly be predicted.

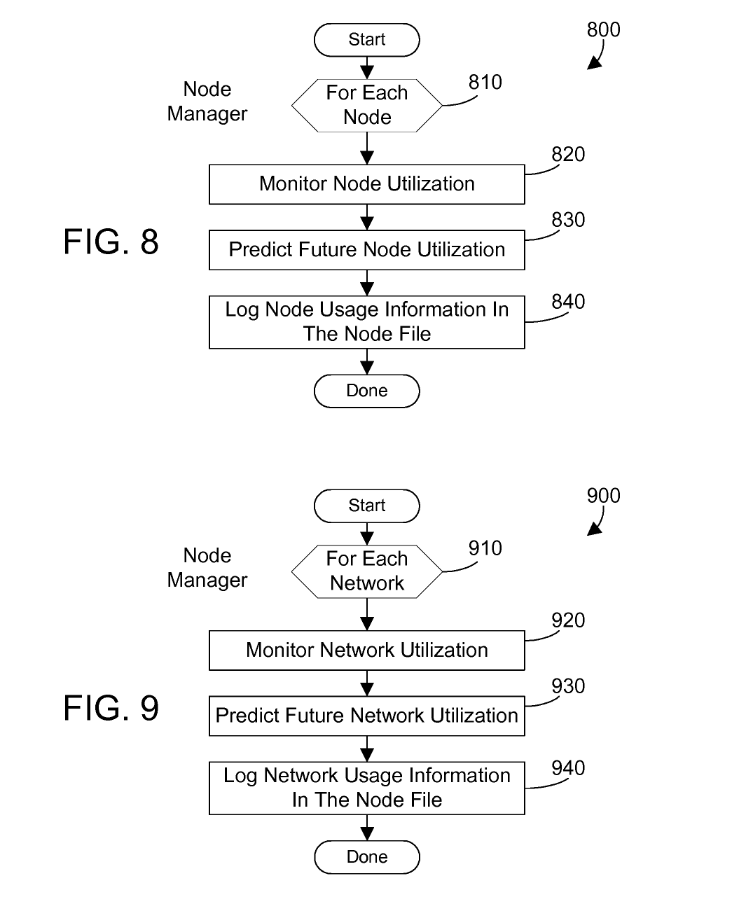

FIG. 8 shows a method 800 for preparing node information to be used to determine optimal pre-loading of an in memory database. The steps in method 800 are performed for each node in the computer system or in a partition of the computer system being pre-loaded (step 810). First, monitor the node utilization of each node (step 820). Next, where possible, predict future node utilization based on the past utilization and other available information about the nodes and node architectures (step 830). Then log the node usage statistics in the node file (step 840). The method is then done.

FIG. 9 shows a method 900 for preparing network information to be used to determine optimal pre-loading of an in memory database. The steps in method 900 are performed for each network in the computer system or in a partition of the computer system being pre-loaded (step 910). First, monitor the utilization of each network (step 920). Next, where possible, predict future network utilization based on the past utilization and other available information about the networks (step 930). Then log the network usage statistics in the network file (step 940). The method is then done.

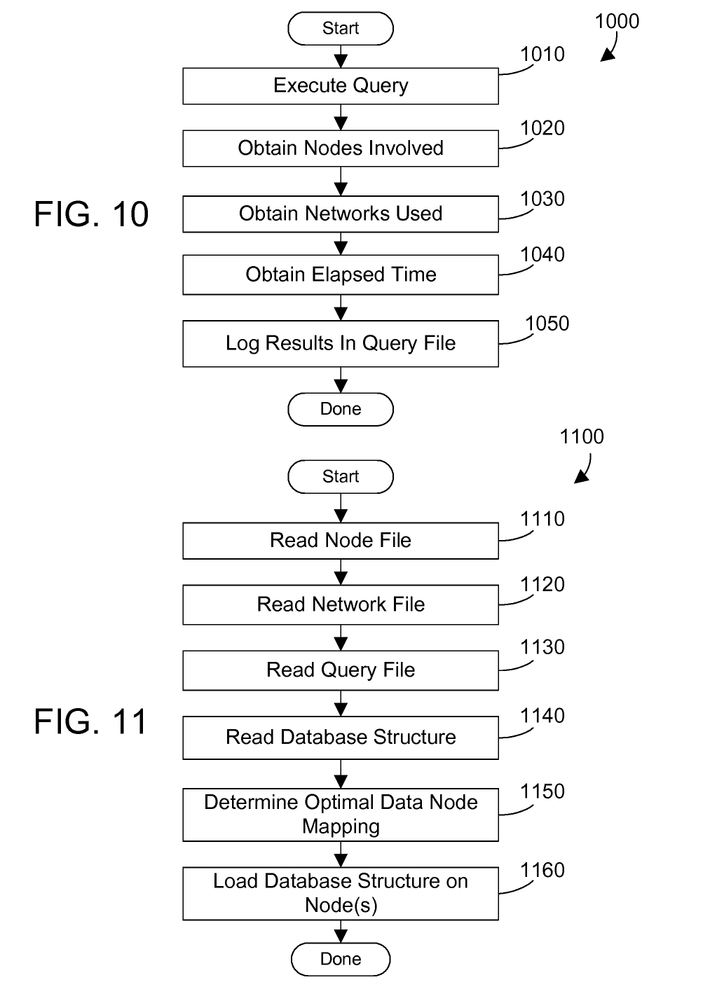

FIG. 10 shows a method 1000 for preparing query information to be used to determine optimal pre-loading of an in memory database. First, execute the query (step 1010). Next, obtain a list of all the nodes involved in the query (step 1020). Then obtain a list of the networks used in the query (step 1030). Also obtain the elapsed time to execute the query (step 1040). Then log the query information in the query file (step 1050). The method is then done.

The node manager (142 in FIG. 1) uses the historical information described above in the process of creating a node map. The node map is an optimal mapping of where to place the database structures in the nodes as described further below. The node map could be a simple list, index or other data structure. In addition to the historical information described above, the node manager can use other inputs to create and update the node map. Other inputs for creating the node map include forced node mapping of data structures and node mapping based the structure of the database itself. Node mapping based on the database structure considers any relationships within the static database that would dictate system performance could be enhanced by mapping database structures in close proximity. For example, if a field in TableA is used as a foreign key in TableB, then it may be beneficial to locate these tables on the same node or in close proximity to each other.

Forced node mapping is where the node manager allows a database administrator to force a database structure to be placed in a particular node. This may be accomplished using a graphical user interface (GUI) that presents a graphical representation of the database to the user that looks like the block diagram of FIG. 4. The GUI would display the nodes and database structures on a display screen and allow a system administrator to pick and place the database structures. The node map would then be updated to reflect the forced mappings selected using the GUI. The forced node mapping is intended to override the node mapping that would be done by the other mapping methods, but provisions in the GUI could be used to allow other mapping methods to trump the forced node mapping.

FIG. 11 shows a method 1100 for pre-loading an in memory database. First, read the node file (step 1110), then read the network file (step 1120) and read the query file (step 1130). These files are those illustrated in FIGS. 5 through 7 and described above. Next, read the database structure that is to be loaded into the in memory database (step 1140). Determine the optimal data node mapping (step 1150), meaning to determine what node or nodes is the optimal place to store the database structure read in step 1140 into the in memory database. Then load the database structure on the optimal nodes (step 1160) and the method is then done.

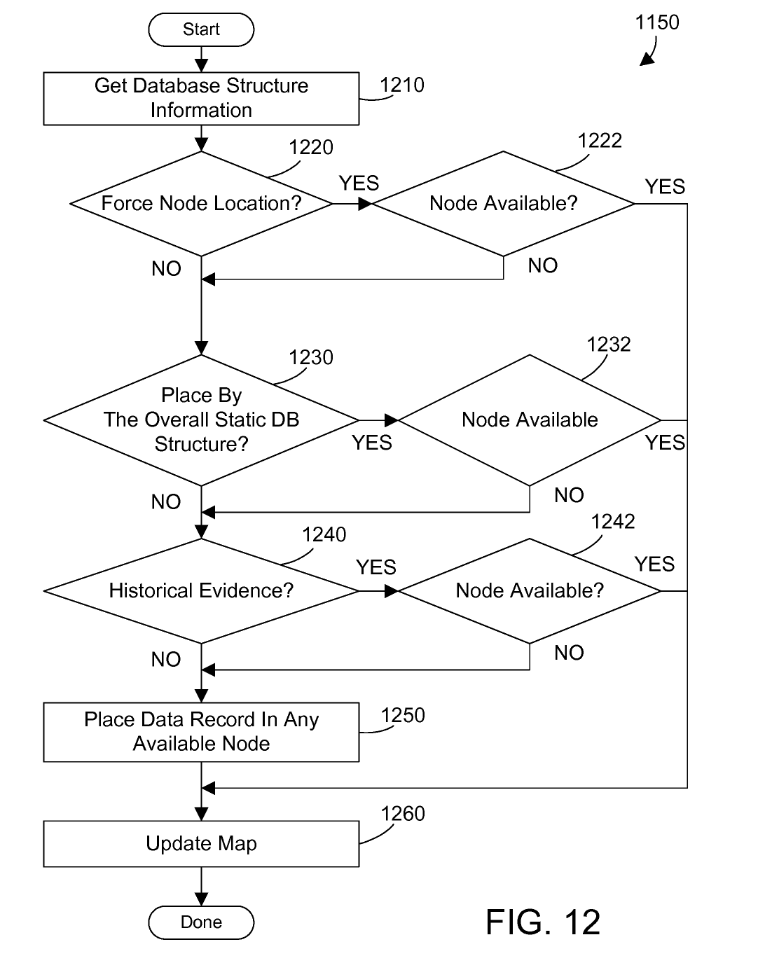

FIG. 12 shows a method 1150 as one possible implementation for step 1150 in FIG. 11. Method 1150 illustrates a method for determining the optimal data node mapping for an in memory database. This method would be executed by the database loader 144 on the service node 140 shown in FIG. 1. This method is executed for each database record to be placed in the in memory database. First, get the database structure to be placed in the in memory database (step 1210). Next, if there is a force node location for this node (step 1220=yes), then check if the node is available (step 1222). If the node is available (step 1222=yes) then go to step 1270. If the node is not available (step 1222=no), or if there is no force node location (step (1220=no) then go to the next step (1230). If the overall static database structure determines the node location for this database structure (step 1230=yes), then check if the node is available (step 1232). If the node is available (step 1232=yes) then go to step 1270. If the node is not available (step 1232=no), or if there is no force node location (step (1230=no) then go to the next step (1240). Next, if there is historical information to locate this database structure (step 1240=yes), then check if the node is available (step 1242). If the node is available (step 1242=yes) then go to step 1270. If the node is not available (step 1242=no), or if there is no historical information to locate this database structure (step (1240=no) then go to the next step (1250). Then place the database structure in any available node (step 1250), since the data was not placed by force, static database structure or by historical information. Then update the map with the database structure/node relationships determined in the above steps (step 1260) and the method is then done.

As described above, embodiments provide a method and apparatus for pre-loading a set of nodes in a computer system such as a massively parallel super computer system. Embodiments herein can significantly increase the efficiency of the computer system.

One skilled in the art will appreciate that many variations are possible within the scope of the present invention. Thus, while the invention has been particularly shown and described with reference to preferred embodiments thereof, it will be understood by those skilled in the art that these and other changes in form and details may be made therein without departing from the spirit and scope of the invention.

What is claimed is:

1. A parallel computer system comprising:
a plurality of fully functional compute nodes;
a node manager for managing the compute nodes and collecting historical information about the operation of an in memory database on the nodes; and
a database loader for pre-loading the in memory database based on the historical information to optimize the database efficiency.

2. The parallel computer system of claim 1 wherein the parallel computer system is a massively parallel computer system.

3. The parallel computer system of claim 1 wherein the node manager creates a node map that reflects the node assignments for database structures to be stored in the in memory database.

4. The parallel computer system of claim 1 wherein the historical information includes information chosen from the following: node information, network information and query historical information.

5. The parallel computer system of claim 4 wherein the node information includes node identification, timestamp, current utilization future utilization and availability.

6. The parallel computer system of claim 4 wherein the network information includes network identification, timestamp, current utilization future utilization and availability.

7. The parallel computer system of claim 4 wherein the query information includes query identification, network used, elapsed time, node list and priority.

8. A computer implemented method for pre-loading an in memory database into the compute nodes of a parallel computer system where the method comprises the steps of:
accessing historical information about the database operating in the computer system;
reading a data file containing a database structures;
determining an optimal compute node mapping for the database structure based on the historical information; and
loading the database structure in the database.

9. The computer implemented method of claim 8 wherein the step of determining an optimal compute node mapping further comprises the step of determining if the database's static structure determines an optimal node location for the database structure.

10. The computer implemented method of claim 8 wherein the step of determining an optimal compute node mapping further comprises the step of determining if there is a force location for the database structure in the in memory database as indicated by a system administrator input.

11. The computer implemented method of claim 10 wherein the step of determining if there is a force location for the database structure in the in memory database as indicated by a system administrator input includes inputting a force location using a graphical user interface.

12. The computer implemented method of claim 8 wherein the step of accessing historical information about the database further comprises the steps of:
monitoring node utilization, predicting future node utilization; and
logging node utilization information in a node file.

13. The computer implemented method of claim 8 wherein the step of accessing historical information about the database further comprises the steps of:
executing a query;
obtaining the nodes involved in the query;
obtaining the networks used in the query;
obtaining the elapsed time to execute the query; and
logging the obtained results of the nodes involved, networks used and elapsed time in a query file.

14. A computer-readable program product comprising:
a node manager for managing the compute nodes and collecting historical information about the operation of an in memory database on the nodes;
a database loader for pre-loading the in memory database based on the historical information to optimize the database efficiency; and
computer recordable media bearing the database loader.

15. The program product of claim 14 wherein the computer system is a massively parallel computer system.

16. The program product of claim 14 wherein the node manager creates a node map that reflects the node assignments for database structures to be stored in the in memory database.

17. The program product of claim 14 wherein the historical information includes information chosen from the following: node information, network information and query historical information.

18. The program product of claim 17 wherein the node information includes node identification, timestamp, current utilization future utilization and availability.

19. The program product of claim 17 wherein the network information includes network identification, timestamp, current utilization future utilization and availability.

20. The program product of claim 17 wherein the query information includes query identification, network used, elapsed time, node list and priority.
